(19) United States
(12) Patent Application Publication
(10) Pub. No.: US 2021/0293559 A1
(43) Pub. Date: Sep. 23, 2021

(54) SYSTEM AND METHOD FOR NAVIGATING A ROUTE BASED ON INTRINSIC CHARACTERISTICS AND FEEDBACK OF THE TRAVELER

(71) Applicant: James Allen Samuel, McLean, VA (US)

(72) Inventor: James Allen Samuel, McLean, VA (US)

(21) Appl. No.: 16/949,875

(22) Filed: Nov. 18, 2020

Related U.S. Application Data
(60) Provisional application No. 62/901,997, filed on Sep. 18, 2019.

(51) Int. Cl. G01C 21/34

(52) U.S. Cl. CPC G01C 21/3484

(57) ABSTRACT

A system and method for navigating a route based on intrinsic characteristics and feedback of the traveler.

### CROSS-REFERENCE TO RELATED APPLICATION

This application claims the benefit of priority of U.S. provisional application No. 62/901,997 filed 18-Sep.-2019, the contents of which are herein incorporated by reference.

### BACKGROUND OF THE INVENTION

The present invention relates to travel planning and route determination and, more particularly, a system and method for navigating a route based on intrinsic characteristics and feedback of the traveler.

Presently, navigation systems, methods, processes, platforms, devices and aides provide suggested routing between destinations based on time, distance, speed, obstacles and other characteristics of the route and/or vehicle and/or environment itself. They do not consider nor utilize the multi-dimensional aspects of the people, entities, animals, machines, and/or objects traversing the route. In other words, current approaches to travel planning do not account for how different types of people, animals, entities and/or objects—i.e., the traveler—prefer or need to travel, given the traveler's unique attributes.

Treating all travelers identically and ignoring their unique characteristics and attributes leads to suboptimal travel recommendations, some of which can be unsafe. But at the very least, the sub-optimized routing instructions tend to diminish the travel experience, given the unique attributes and/or characteristics of each traveler. By spitting out non-specific travel itineraries to the people, entities, animals, machines and/or objects traveling a route, this traveler is only provided a partial solution in the form of speed, time and routing optimization given the quickest and least obstructed paths.

As can be seen, there is a need for a system and method for navigating a route based on intrinsic characteristics and feedback of the traveler. The present invention provides people, entities, animals, machines and/or objects (the travelers or “traveling entities”) routes between destinations, wherein the routes are optimized for the traveling entity, based on the travel entity's inputted intrinsic characteristics and attributes, such as (but not limited to) physical, social, cultural, racial, sexual, emotional, electrical, religious, class, dietary restrictions/preferences, income bracket, net worth, and/or any other intrinsic characteristic that distinguishes one traveling entity from another.

The present invention still provides speed, time and routing optimized for quickest and least obstructed paths though also factors in the unique attributes of the traveler to determine travel itineraries, routing options and/or paths that are optimized for their intrinsic characteristics, attributes and type that is the unique traveler entity. This specialized routing increases comfort, safety, and traveler experiences along said route, recognizing that no two routes are equally optimal for different traveling entities, which are themselves unique, with unique needs.

### SUMMARY OF THE INVENTION

In one aspect of the present invention, a system and method for navigating a route based on intrinsic characteristics and feedback of the traveler includes the following systemic components: (a) requesting that a traveling entity of a network provide one or more intrinsic characteristics; (b) computing a plurality of navigation routes from a departure point to one or more destination points; (c) generating one or more route recommendations associated with each possible navigation route based on the acquired intrinsic characteristics; (d) determining a preferential data set based in part on an affinity between the intrinsic characteristics and one or more points of interest of each route recommendation; (e) assigning, by one or more processors of the network, weight values for each of the one or more route recommendations based on the affinity of each preferential data set; and (f) calculating, by one or more processors of the network, a weighted rank for each of the one or more route recommendations based on the assigned weight values. In another aspect of the present invention, the above method further includes extracting, by one or more processors of the network, external data associated with the one or more intrinsic characteristics from one or more social media websites affiliated with the traveling entity, wherein the route recommendations of step (c) are generated based in part on the extracted external data; and prompting, by the network, that the traveling entity provide a feedback data in response to said weighted rank, wherein the route recommendations of step (c) for another traveling entity of the network are generated based in part on the feedback data for a future navigation routes comprising one or more destination points.

These and other features, aspects and advantages of the present invention will become better understood with reference to the following drawings, description and claims.

### BRIEF DESCRIPTION OF THE DRAWINGS

FIG. 1 is a diagrammatic view of an exemplary embodiment of the present invention illustrating the systemic software or other manifestations of the system 100 of the present invention; and

FIG. 2 is a diagrammatic view of an exemplary embodiment of a network 200 of the present invention, it being understood that there can be more than the two user devices shown.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

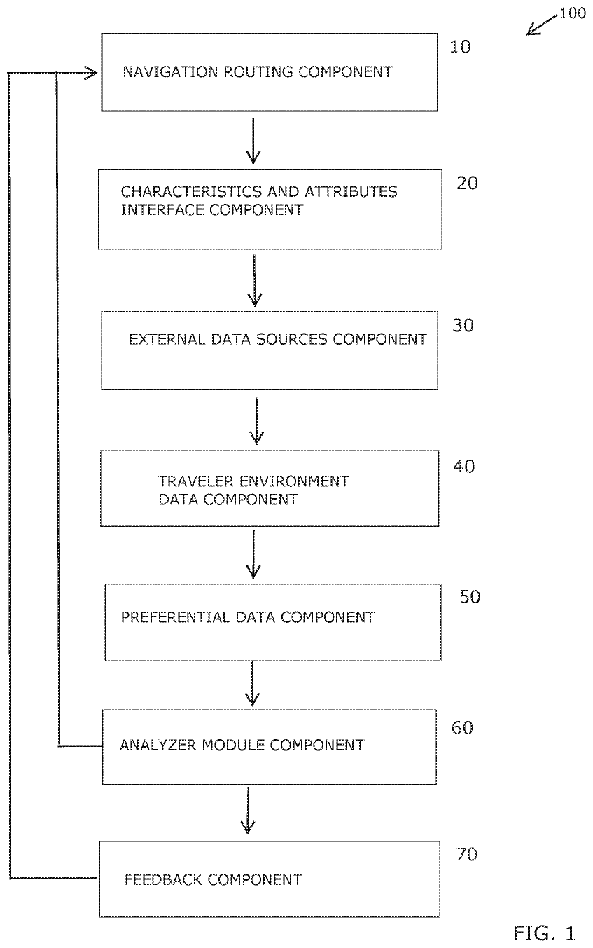

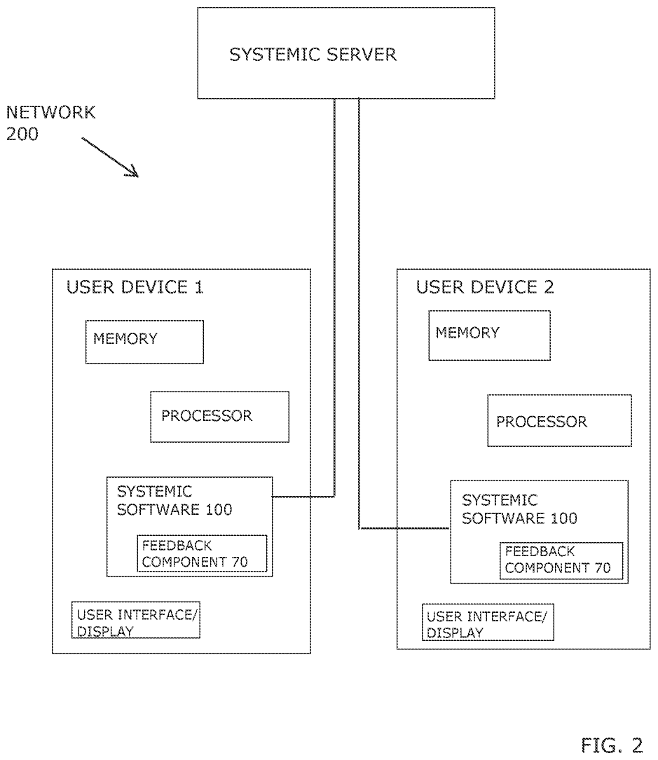

Referring now to FIGS. 1 and 2, system (systemic software) 100 embodied in the present invention may include the following systemic components.

1. Navigation Routing Component 10

The Navigation Routing Component may be configured to determine a plurality of travel routes between a departure point A and one or more destination points Bⁿ based on extrinsic conditions. Extrinsic conditions may include timing constraints, distance, speed, obstacles and other characteristics of the route and/or a mode of transportation and/or environment itself, including as but not limited to traffic flow, network-user-supplied traffic volume, weather and road conditions. Thus, based on the information concerning such extrinsic conditions received from, say, a server via the Internet, the navigation routing component is configured to determine the most time-efficient routes and distance-efficient routes, e.g., one that requires the least travel time, to accomplish the trip's purpose despite any extrinsic conditions, as well as a plurality of travel routes that interconnect the departure point A and the one or more destination points Bⁿ.

2. Characteristics and Attributes Interface Component 20

The Characteristics and Attributes Interface prompts and receives input from users regarding intrinsic characteristics—i.e., attributes intrinsic to a user/traveling entity. These intrinsic characteristics of the traveling entity may include but are not limited to physical, social, cultural, racial, sexual, emotional, electrical, religious, class, dietary restrictions/preferences, income bracket, net worth, and/or any other characteristic that distinguishes one travel entity from another.

When a user initially utilizes the present invention for travel planning in accordance with the invention, a systemic server is configured to generate the Characteristics and Attributes Interface, typically through a user's computing device, wherein the user/travel entity is prompted for entering his/her personal data, e.g., his/her name, age, sex, marital status, occupation, city, education, religion and number of children, which are stored as intrinsic characteristics.

In certain embodiments, the user may be prompted to select preferences from different categories to be included in the personal data/intrinsic characteristics, including but not limited to music, entertainment, shopping, recreation categories. Input may be through any form of electronic input, including but not limited to a computer's user interface by way of any suitable peripheral input/output device.

3. External Data Sources Component 30

The present invention may include other external data sources, such as but not limited to social-media and other data sources about the user/traveling entity, about a local environment of each of the destinations, and about events associated with the environment of the destinations within the timing constraints.

The external data sources may include media sources, such as social network services, online communities, and online news sources. Information received from the external data sources may include information associated with social networks, blogs, and websites having a registered profile of the traveling entity, among other information. Information from the external data sources may be accessed and parsed through a data mining engine via the systemic network 200.

4. Traveler Environment Data Component 40

Traveler environment data may include information about the traveling entity's environment that affect the intrinsic characteristics and attributes, such as (but not limited to) physical, cultural, sexual, emotional, electrical, religious, class, dietary restrictions/preferences, income bracket, net worth, and/or any other characteristic that distinguishes one entity from another.

5. Preferential Data Component 50

Preferential data and other information about the traveling entity's environment that provides products, services, experiences, and the like, that are of interest or preference or benefit to the traveling entity, in full consideration of the intrinsic characteristics and attributes of the traveling entity may be determined (or “predetermined”) by a preferential data component.

The predetermined preferential data may be utilized to adjust weightings of the routes and travel itineraries generated by the Navigation Routing Component. For instance, when a user/traveling entity plans to go from a departure point A to a destination point B, the Navigation Routing Component may compute travel itineraries or routes R1 and R2 according to the extrinsic conditions, intrinsic characteristics, external data sources and traveler environment data, then the present invention may reweight (possibly by way of an analyzer module discussed more below) each route after integrating the predetermined preferential data, which is a function of the extrinsic conditions, intrinsic characteristics, external data sources and traveler environment data. Through this iterative modality, the present invention is configured to optimize the route navigation process by integrating traveling-entity specific data inputted and subsequently determined.

The predetermined preferential data is stored in the systemic memory in such a way that when the Navigation Routing Component determines one or more predetermined preferential data is associated with, say, route R2, the Navigation Routing Component and/or analyzer module may adjust the weighting of route R2 so that route R2 can be automatically selected by the Navigation Routing Component for navigating the user from the departing point A to the destination B, so that the user/traveling entity passes or intersects the predetermined preferential data while traveling along route R2. Likewise, the Navigation Routing Component may adjust weightings of travel itineraries/routes in which the preferential data is located with different magnitudes.

6. Analyzer Module Component 60

The analyzer module is configured to combine, analyze, contextualize and convey Components 1-5 to the user/traveling entity via a delivery platform carried upon themselves and/or integrated into their mode of transportation and/or integrated into their device of preference (such as a networked and integrated home, business computing device, and/or that of another user/traveling entity).

The present invention being a method and system for route personalization is configured to integrate contextual data and extrinsic conditions embodied in Components 1-5 into route and/or travel itinerary determinations. The method and system are configured to provide weighted recommendations regarding a travel route or itinerary to a user based on these user-provided extrinsic conditions and contextualized data (intrinsic characteristics, external data, travel environment data, and preferential data).

In certain embodiments, the user may request a map of a route for travel from a departure point A to one or more destination points Bⁿ, for example, on a user device. The user device may be any computing device, as described herein. The user may launch the Navigation Routing Component configured to generate one or more possible routes R1-Rn, between A and Bⁿ. The user may also launch the Characteristics and Attributes Interface configured to prompt and receive user-inputted intrinsic data. The analyzer module may be configured obtain the external data sources and travel environment data to generate weighted recommendations for each route generated by the Navigation Routing Component. (In certain embodiments, the user may be asked to provide the external data sources and traveler environment data.)

Preferential data may then be determined by the referential data component or analyzer module based on the intrinsic characteristics, external data sources and traveler environment data ('traveling entity data') for the possible routes generated by the Navigation Routing Component. The resulting predetermined preferential data may then be analyzed by the analyzer module and integrated into the Navigation Routing Component based on the intersection/association of the predetermined preferential data for each possible route. Thereby reweighted route recommendations may then be generated for each possible route based on the acquired traveling entity data and predetermined preferential data. The routes and weighted recommendations may then be displayed to the user via the user device. The user may then select a personalized route based on the weighted recommendations, as well as provide feedback regarding each listed weighted recommendation by way of a feedback component.

7. Feedback Component 70

The feedback data from the above-mentioned feedback component for each route recommendation displayed via Component 6, may be reintroduced to a collective, systemic network 200 of users/travel entities, thereby enriching and adding value to the travel experiences as the feedback data embodies positive/negative experiences of each user/travel entity for a potential route or a similar route or environment. Sharing the added and shared perspective of the intrinsic characteristics and attributes of the traveling entities adds another layer of iterative optimization.

The present invention produces an optimized travel solution for each person, entity, animal, machine, and/or object traversing a local route or environment, or a similar route or environment in a different location, or a completely unknown route, given the added and shared perspective of the local, current, previous or even distant traveler, based on their intrinsic characteristics and attributes, such as, but not limited to, physical, social, cultural, racial, sexual, emotional, electrical, religious, class, dietary restrictions/preferences, income bracket, net worth, and/or any other characteristic that distinguishes one travel entity from another.

The logic of the present invention may include the follow: (Sum of Components 1-5=Component 6)+User Response/Feedback=Component 7, which further refines/enriches Components 3-5, which are reinserted into the Sum of Components 1-5, thereby serving as a continuously-refined feedback loop.

A user of the present invention can input their personal attributes and characteristics such as (but not limited to) physical, social, cultural, racial, sexual, emotional, electrical, religious, class, dietary restrictions/preferences, income bracket, net worth, and/or any other characteristic that distinguishes one travel entity from another. The present invention then utilizes the combination of the above-listed components to assist the user/traveler by providing idealized travel route and/or services enroute to their destination point(s), thus increasing their user/traveler experience and adding value to their lives or existence (in the case of an entity or object).

Additionally, the present invention can also be used to understand and predict the travel, migratory, spending, and socio-economic patterns of people, entities, animals, machines, and/or objects, to the extent that supportive services (such as healthcare) can be offered and rendered when needed, even without the direct request of the party in need. For example, if someone who cannot swim travels into a rapidly flooding area, the present invention will recognize the confluence of a dangerous setting (via local weather information) and a person who lacks the ability to safely navigate that environment (based on their highly-refined user profile/intrinsic characteristics, as generated by the above-listed components of the present invention). The present invention will then possess the awareness and intelligence (artificial or otherwise) to alert emergency services of this endangered individual's whereabouts and probability of peril, with the pre-consent of the individual, to avail these emergency services of the potentially required life-saving services (especially if they become incapacitated).

The present invention can also produce tailored tours of geographic areas, based on the above-listed components.

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof. The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-Fl network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-Fl network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A method comprising:
(a) requesting that a user of a network provide one or more intrinsic characteristics;
(b) computing a plurality of navigation routes from a departure point to one or more destination points;
(c) generating one or more route recommendations associated with each possible navigation route based on the acquired intrinsic characteristics;
(d) determining a preferential data set based in part on an affinity between the intrinsic characteristics and one or more points of interest of each route recommendation;
(e) assigning, by one or more processors of the network, weight values for each of the one or more route recommendations based on the affinity of each preferential data set; and
(f) calculating, by one or more processors of the network, a weighted rank for each of the one or more route recommendations based on the assigned weight values.

2. The method of claim 1, further comprising:
extracting, by one or more processors of the network, external data associated with the one or more intrinsic characteristics from one or more social media websites affiliated with the user, wherein the route recommendations of step (c) are generated based in part on the extracted external data.

3. The method of claim 2, wherein the user is a machine.

4. The method of claim 2, wherein the one or more intrinsic characteristics comprises emotional attributes and a net worth of the user.

5. The method of claim 2, further comprising:
prompting, by the network, that the user provide a feedback data in response to said weighted rank, wherein the route recommendations of step (c) for another user of the network are generated based in part on the feedback data for a future navigation routes comprising one or more destination points.
